(19) United States
(12) Patent Application Publication
(10) Pub. No.: US 2026/0193425 A1
(43) Pub. Date: Jul. 9, 2026

(54) METHOD OF MAKING PARTICLES

(71) Applicant: Victrex Manufacturing Limited, Thornton Cleveleys, Lancashire (GB)

(72) Inventors: Adam Chaplin, Thornton Cleveleys, Lancashire (GB); Martin Riley, Thornton Cleveleys, Lancashire (GB)

(21) Appl. No.: 19/134,388

(22) PCT Filed: Nov. 23, 2023
(86) PCT No.: PCT/GB2023/053058

§ 371 Date: May 30, 2025

(30) Foreign Application Priority Data
Dec. 1, 2022 (GB) 2218077.2

(51) Int. Cl. C08J 3/12; C08J 3/26

(52) U.S. Cl. CPC C08J 3/126; C08J 3/128; C08J 3/26; C08J 2371/00

(57) ABSTRACT

Particles are provided for use in layer-wise formation of components by selective sintering by electromagnetic radiation. The particles either consist essentially of 60 to 100% by weight of polyaryletherketone, PAEK polymer and 0 to 40% by weight of filler or are such particles with a shell consisting of secondary particles having a melting temperature which is greater than the melting temperature of the PAEK polymer. The particles have a total porosity from 0.58 to 0.40 5 derived from comparison of open pore volumes of a sample of the particles measured by mercury intrusion porosimetry at pressures of 0.33 psia (2.3 kPa) and 59950 psia (413.3 MPa) respectively. Components made from the particles by selective sintering by means of electromagnetic radiation exhibit improved properties.

The invention relates to particles comprising or consisting of polyaryletherketone polymers which are suitable for use in the formation of components by selective sintering and melt-bonding of sequentially deposited layers including the particles. The invention also relates to methods for preparing the particles and their use in component formation.

Methods in which rapid manufacturing of components is carried out from construction data under computer control are sometimes referred to as rapid prototyping methods. In prior art methods the component to be manufactured is built layer-wise from a building material. In some prior art methods, the building material is in particulate form, with the uppermost layer of particles selectively sintered using electromagnetic radiation, for instance by selective heating with a laser, in order to melt-bond particles together, and to melt bond them to the layer on which they are deposited, in order to form a melt-bonded cross-sectional layer of the component.

Such methods are, for example, referred to by the names 3D laser sintering, 3D laser melting or 3D printing. Metals, ceramics and plastics may be used as particulate building materials. For instance, the U.S. Pat. No. 5,730,925 describes a laser sintering method, in which layers of powder particles are applied onto a support that can be vertically repositioned and in which the layers are selectively sintered at the positions corresponding to the cross-section of the object to be manufactured by means of a laser.

Originally, such methods were limited to prototyping, but now the methods are used for component manufacture. In this specification, such methods will be referred to by the term additive layer manufacturing (ALM), indicating that 3D parts are constructed by the build-up of successive layers. This may be contrasted with traditional manufacturing by milling, in which material is removed, or “subtracted”, from a starting blank in order to arrive at a desired component shape.

Layer-wise manufacturing of a three-dimensional object may be performed using selective fusion of layers of a bed of particles. Devices adapted for the production of objects from polymer particles are commercially available, for instance the EOS P series of devices is available from EOS GmbH.

Such devices may employ a laser beam or focused light beam for sintering, but other systems to selectively deliver electromagnetic radiation may be used, such as mask exposure systems or the like.

A variety of different types of polymeric materials has been proposed for use as building materials in ALM. Polyaryletherketone polymers, referred to herein as PAEK polymers, have been found to be particularly useful, as components that have been manufactured from PAEK particles or PAEK granulates are typically characterized by a low flammability, good biocompatibility as well as a high resistance against hydrolysis and radiation. It is the thermal resistance at elevated temperatures as well as the chemical resistance that distinguishes PAEK particles from conventional polymer powder particulates such as polyamides, polyesters and the like. The high-performance characteristics of PAEK polymers, combined with their low density, make them of use in the aerospace industry, in the automotive industry, in the electronic industry and in the medical industry.

Patent application publication US2006/0134419A discloses a polymer powder containing polyaryletherketone and having a BET surface area from 1 to 60 m²/g. The disclosure mentions polyaryletherketones selected from PEEK, PEK, PEKK and PEEKK although the only polymer specifically exemplified is PEEK. The porous PAEK is disclosed as being formed by extraction with an aprotic solvent and milled, preferably at temperatures below 0° C., to form a powder (i.e. particles). PEEK powders with bulk densities up to 499 g/L are disclosed (corresponding to a total porosity of 0.62 as measured herein, assuming 1.32 g/mL as the density of PEEK).

U.S. Pat. No. 7,847,057B2 sets out to improve the properties of PAEK particles, as ALM building materials, by tempering for at least 30 minutes at a temperature which is at least 20° C. above the glass transition temperature (Tg) of the PAEK polymer to improve uniformly and evenness of an applied layer to improve accuracy of manufacturing of parts when the particles are used for manufacture by laser sintering. The publication refers to polyaryletherketones and makes reference to the group consisting of polyetheretherketone (PEEK), polyetherketoneketone (PEKK), polyetherketone polyetheretherketoneketone (PEEKK) (PEK), and polyetherketoneetherketoneketone (PEKEKK). PEEK is the polymer used in the Examples of this patent. Example 7 of this disclosure discloses a PEEK powder with a bulk density of 0.48 g/cm³ prepared by annealing in a shear mixer. This corresponds to a total porosity of 0.64 as measured herein.

U.S. Pat. No. 10,882,215B2 discloses a method of producing heat-treated PEKK powder having a median particle diameter between about 10 μm and about 150 μm. In the Examples there is disclosed a PEKK powder having a bulk density as measured on a Freeman Technology FT-4 Powder Rheometer of 0.47-0.52 g/mL. Assuming a skeletal density of 1.28 g/ml for PEKK, this corresponds to a total porosity range of 0.63 to 0.59.

A problem with PAEK polymer particles for use in ALM is their low bulk density (high total pore volume) and their relatively poor flow characteristics. It would be desirable to reduce pore volume and improve particulate flow and to improve uniformity and even distribution of sequentially applied layers of powder particles to improve accuracy of manufacturing of parts when the particles are used for manufacture by laser sintering. Also, components made by ALM, using PAEK polymer particles as building material are typically lower in strength and higher in porosity than components made by injection moulding of the same PAEK, with this difference thought to partially arise from the low bulk density of the sequentially layered particles.

It is an object of the invention to address one or more of the above-described problems.

One aim of the invention, amongst others, is to provide polymeric particles comprising PAEK polymer which can be used as building materials in ALM (such as selective laser sintering) to generate components which have good uniformity, low porosity and good mechanical and chemical resistance properties compared to components made from prior art PAEK particles. It is a further aim of the invention to provide polymeric particles which are flowable. It is a further aim of the invention to provide polymeric particles which have a low total porosity. It is a further aim of the invention to provide particles which can be used to form components by ALM with the resulting components having high density and low porosity in combination with excellent mechanical properties.

The inventors have found that mechanical fusion may be used to treat the PAEK particles prior to their use in ALM and that results in PAEK particles which can address the problems set out above. In particular, the particles of the invention can provide improved high bulk density, low total porosity and good flow for the particles. This provides reduced porosity and improved mechanical strength for components made from the PAEK particles using ALM. The PAEK particles of the invention may optionally including a filler in combination with the PAEK polymer, as discussed below, or the particles may consist essentially of the PAEK polymer (i.e. with the only other materials present being by-products or impurities arising from the synthesis of the polymer).

In ALM processes for component manufacture, some particles are intentionally not mutually bonded to other particles during processing and ideally these are re-used in subsequent ALM processes rather than being wasted. The particles of the invention have also been found to be easily re-usable in subsequent ALM manufacturing processes after a first ALM process in which the particles were not incorporated into the component.

Throughout this specification, the term “comprising” or “comprises” means including the component(s) specified but not to the exclusion of the presence of other components.

The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and may also be taken to include the meaning “consists of” or “consisting of”.

As used herein, the term “nucleophilic condensation” is used to refer briefly to the process for preparation of PAEK by nucleophilic polycondensation of bisphenols with organic dihalide compounds, in the presence of alkali and/or alkali earth metal carbonates and/or bicarbonates in the presence of an aromatic sulfone polymerisation solvent such as diphenyl sulfone (DPS). Such processes are well known and established in this field.

The PAEKs referred to herein will also include, in addition to the polymer chains, certain reaction by-products from their manufacture, such as residual solvent, residual salts and residual monomer. Hence, the use of the term PAEK refers to the polymer itself, but it must be understood that the term encompasses the presence of residual by-products, along with the polymer chains of the PAEK, arising from the copolymer manufacture, present as up to say 5% by weight of the final product of manufacture, for instance up to 2% by weight, such as 1% by weight, with the remaining material being the PAEK polymer itself.

References to the monomers, solvents and other additives of the nucleophilic condensation reaction are meant to refer to these compounds used with their commercially available purities, without need for further special purification.

A first aspect of the invention provides particles, for use in layer-wise formation of a component by selective sintering with electromagnetic radiation, the particles consisting essentially of, or consisting of, 60 to 100% by weight of polyaryletherketone, PAEK polymer and 0 to 40% by weight of filler, wherein the particles have a total porosity from 0.58 to 0.40, derived from comparison of open pore volumes of a sample of the particles measured by mercury intrusion porosimetry at pressures of 0.33 psia (2.3 kPa) and 59950 psia (413.3 MPa) respectively.

Mercury porosimetry provides a method for the measurement of the total volume of pores in a sample between upper and lower limits of pore sizes. The porosity or void fraction of a sample of powder (i.e. solid) particles is the ratio of the volume of pores to the volume of solid. For instance, for spherical particles of uniform diameter and with no intraparticle pores, the theoretical “close-packed” minimum pore volume is about 0.26. This rises to 0.36 for random packing of such spheres.

In mercury intrusion porosimetry, these volumes are measured by monitoring the volume of mercury intruded into the penetrometer chamber holding the sample of powder particles as a function of increasing intrusion pressure. Each value of the intrusion pressure corresponds to an equivalent pore diameter. The values of 0.33 psia and 59950 psia correspond to the diameters of the largest open interparticle pores (voids between the particles in the powder sample) and the smallest open intraparticle pores (within the particles of the powder sample).

The bulk volume of the sample corresponds to the volume of the penetrometer chamber minus the volume of mercury intruded up to 0.33 psia (V_{B}) and the volume of the interparticle and intraparticle pores corresponds to the volume of mercury intruded between the pressure values 0.33 psia and 59950 psia (V_{P}). The total porosity is V_{P}/V_{B}.

It must be noted that this total porosity includes both interparticle pores and intraparticle pores associated with the powder sample held within the penetrometer chamber of the mercury intrusion apparatus. As mercury is intruded, the powder sample will be consolidated into a mass of particles by the mercury, which will not penetrate the interparticle pores (i.e. the voids between the particles) at the lower pressure of 0.33 psia. As the intrusion pressure increases, the mercury will penetrate the voids between the particles and eventually, at higher pressures, will also penetrate into open-ended pores within the particles (intraparticle pores). Usually, there will be a distinct transition in the curve plotting intruded volume of mercury as a function of intrusion pressure corresponding to the transition from filling of interparticle pores to filling of intraparticle pores. This may enable the total pore volume to be separated into the individual contributions from the interparticle pores of the powder sample and the intraparticle pores intrinsic to the particles themselves. The total porosity of a sample of particles, as discussed herein, means:

(volume of interparticle pores+volume of intraparticle pores)/(bulk volume of sample)

The bulk volume of the sample is volume of interparticle pores+volume of intraparticle pores+volume of the solid and non-accessible pores within the particles. As explained above, this is equivalent to the volume of the penetrometer chamber minus the volume of mercury intruded up to 0.33 psia, by which stage the bulk sample is surrounded and encapsulated by the mercury.

A suitable mercury porosimeter is an AutoPore IV 9620 mercury porosimeter (Micromeritics). The sample of particles for use in the mercury penetrometer will typically have a volume of 2-4 cm³ with the penetrometer having a chamber volume of about 5 cm³.

Typically, for prior art PAEK powder particles having particle sizes of 200 μm or less (expressed as D90), the total porosity value, as measured by mercury porosimetry described above, between the two specified intrusion pressures, would be about 0.7.

Suitably, the particles of the first aspect of the invention may have a median diameter D50, such that 50% by volume of the particles have a diameter less than D50, wherein D50 is from 20 to 120 μm, preferably from 20 to 80 μm, more preferably from 35 to 70 μm.

Suitably, the particles of the first aspect of the invention may have a D90, such that 90% by volume of the particles have a diameter less than D90, wherein D90 is 300 μm or less, preferably 150 μm or less, such as from 100 to 150 μm.

Suitably, the particles of the first aspect of the invention may have a D10, such that 10% by volume of the particles have a diameter less than D10, wherein D10 is 10 μm or more, such as from 10 to 30 μm.

Such powder particle size characteristics allow for good flow of the particles in combination with the ability to provide relatively high-resolution shaping of a component formed from the powder as building material using ALM.

The particle size distributions set out above may be achieved by known classification methods, such as sieving.

A suitable method for measuring particle size distribution for the powder is by dynamic light scattering analysis using an apparatus such as a Micromeritics Saturn Digisizer 5200. The powder may be dispersed in a suitable dispersant solution such as 6.7 g sodium hexametaphosphate and 1.3 g sodium hydrogen carbonate dissolved in 2 litres of deionised water, with the particle size distribution measured on a dilute dispersion. The volume distribution of the particles is used as basis for establishing D10, D50 and D90, but it will be understood that this is equivalent to D10, D50 and D90 based on a weight distribution. In order to derive a weight distribution from dynamic light scattering data, it is necessary to assume a uniform density for all particles measured, as the apparatus software derives weights and volumes for the particles based upon their cross-sectional area as measured, assuming that the particles are spherical.

The term polyaryletherketone (PAEK) refers to polymers which have aryl groups such as phenyl or biphenyl linked by ether and ketone linkages. The phenylene moieties are suitably linked at the 1,4 for phenyl (or 4,4′ for biphenyl) carbon atoms—to provide a linear polymer chain. This results in the polymeric material being more crystalline in nature.

The PAEK of the primary particles may be any suitable PAEK such as PEEK (polyetheretherketone), PEK (polyetherketone), PEKK (polyetherketoneketone) or PEEKK (polyetheretherketoneketone). Copolymer PAEKs such as PEEK/PEDEK are also suitable, where PEDEK is polyetherdiphenyletherketone. The PAEK of the primary particles may be a single type of PAEK polymer or may be a blend or mixture of two or more such PAEK polymers.

The PAEK may suitably have a shear viscosity from 130 to 430 Pa·s, preferably from 205 to 390 Pa·s, as measured using capillary rheometry at 400° C. at a shear rate of 1000 s⁻¹ by extrusion through a tungsten carbide capillary die of 0.5 mm diameter and 8.0 mm length. Shear viscosity is measured in accordance with the principles set out in ASTM D3835 and ISO 11443. The term shear viscosity is used herein to avoid confusion with extensional or elongational viscosity.

The shear viscosity of the PAEK copolymer is suitably measured by capillary rheometry using an RH10 capillary rheometer (Netzsch RH10 capillary rheometer), fitted with a tungsten carbide die (die diameter: 0.5 mm±0.005 mm, die length: 8 mm). The die is mounted at the bottom of the barrel bore, and its dimensions define the applied shear field. A melt pressure transducer is mounted in the barrel to measure the resultant pressure at the die entrance as the material is extruded. Approximately 35 grams of PAEK is placed into an aluminium dish and dried in an air circulating oven for a minimum of 3 hours at 130° C.±5° C. The extruder is allowed to equilibrate to 400° C. and the die is tightened to 37 Nm after allowing heat expansion for 5 minutes. The RH10 transducers are then calibrated and zeroed using the “Flowmaster®” software. The dried polymer is loaded into the heated barrel of the extruder. The test is started by selecting ‘Run Test’ in the software. After an initial 6 minute pre-heat stage, force is applied to the sample according to the test method and the molten polymer is extruded through the die to form a thin fibre. In the ‘Analysis Tab’ of the software, the shear viscosity (Pa·s) is reported at the specified shear rate (1000 s⁻¹ in this case).

The particles may optionally include a filler, which, if present, may be present as up to 40% by weight of the particles. The term filler as used herein means any material other than PAEK polymer.

The filler may include a fibrous filler or a non-fibrous filler. The filler may include both a fibrous filler and a non-fibrous filler.

The fibrous filler may be selected from inorganic fibrous materials, non-melting and high-melting organic fibrous materials, such as aramid fibres, and carbon fibre.

The filler may be selected from glass fibre, carbon fibre, asbestos fibre, silica fibre, para-aramid fibre, Kevlar fibre, ceramic fibre, alumina fibre, zirconia fibre, boron nitride fibre, silicon nitride fibre, boron fibre, fluorocarbon resin fibre and potassium titanate fibre, mica, silica, talc, hydroxyapatite (Ca₁₀(PO₄)₆(OH)₂), alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, and/or barium sulphate.

The filler may be polymer fibre or particles wherein the polymer is a polymer other than a PAEK polymer. In such an example, the polymer may be selected to have a melting temperature greater than the melting temperature of the PAEK polymer of the primary particles. In another example, the filler may be a liquid crystalline polymer. However, it is preferred that the PAEK polymer of the particles is the sole polymer present in the particles.

Additional materials that may be included in the particles as filler include ingredients such as:
flow aid particles,
radiation absorbers, adhesion promoters, impact modifiers, conductivity modifiers, and rheology modifiers,
density modifiers (e.g. hollow spheres, heavy metals),
thermal and electrical conductivity modifiers, and -tribological modifiers.

Mixtures of fillers may be employed.

Suitable radiation absorbers include carbon black, copper hydroxide phosphate (CHP), chalk, animal charcoal, carbon fiber, graphite, flame retardant, talc, silica, interference pigments and mixtures thereof. Suitable radiation absorbers may be particles having a median diameter of 1 μm or less.

Suitable tribological modifiers include carbon fiber and PTFE. Suitable conductivity modifiers include carbon fiber and boron nitride. The feedstock composition may further include a viscosity modifier such as ethylene-octene copolymer such as Paraloid 3815, buytyl acrylate/PMMA core-shell such as Paraloid 3361, silicone such as Kaneka Kane-Ace MR02, or polyoctohedralsilsesquioxane compounds.

In an embodiment, the particles may consist of from 0 to 5% of filler with 95 to 100% of the PAEK polymer. In another embodiment, the particles may be free from filler, such that the particles consist essentially of, or consist of, the PAEK polymer.

In a preferred embodiment, the PAEK polymer in the primary particles of the first aspect of the invention is a copolymer comprising repeat units of formula:

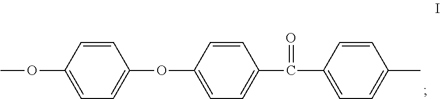

and
repeat units of formula

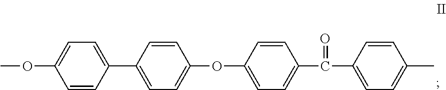

wherein at least 95 mol % of the copolymer repeat units are repeat units of formula I and of formula II, wherein the repeat units I and II have a molar ratio I:II from 55:45 to 80:20.

For the sake of conciseness, units of formula I and formula II are referred to as PEEK and PEDEK respectively in this specification, with this copolymer referred to as a PEEK/PEDEK copolymer. Typically, the polymer will also have end units, which may be the same as the repeat units, but with a terminal OH or F group. However, the process for forming the polymer may include a separate end-capping step at completion of polymerisation, in which case separate monomer or reagent may be added as end-capping agent so that the end units may differ from the repeat units of the polymer. Such end-capping is well known in the field of nucleophilic polycondensation reactions.

In other words, for the polymer of the invention, 95 mol % or more of all repeat units present are units of formula I and of formula II in the specified molar ratio I:II from 55:45 to 80:20. This may be established by virtue of knowledge of the numbers of moles of monomers employed in in the preparation of the polymer. Preferably, at least 98 mol % of the copolymer repeat units are repeat units of formula I and of formula II, more preferably 99 mol %. Most preferably, the polymer consists essentially of repeat units of formula I and formula II.

The PEEK/PEDEK copolymer of this embodiment of the invention may suitably be made using a nucleophilic polycondensation of a mixture of benzene-1,4-diol and 4,4′-biphenol in a suitable molar ratio along with 4,4′-dihalobenzophenone in a reaction mixture comprising sodium carbonate and potassium carbonate in an aromatic sulfone solvent such as diphenylsulfone. Such PAEK preparation processes are well known in this field. It will be understood that the PAEK copolymer of the invention is expected to be a statistical or random copolymer, rather than a block copolymer, as a consequence of the manufacturing method (nucleophilic polycondensation) used for its formation.

The particles of the first aspect of the invention may be made by the method of the third aspect of the invention, as set out below, which involves treatment of primary particles by mechanical fusion. The particle size distribution of the primary particles used in the method of the third aspect of the invention will largely determine the particle size distribution of the resulting particles having the required porosity, although there may be some modifications to the particle size distribution arising from the mechanical fusion step. However, the particle size distribution of the resulting particles may be adjusted by sieving (i.e. classification) after the treatment by mechanical fusion has been carried out.

A second aspect of the invention provides core-shell particles consisting of core particles which are particles according to the first aspect of the invention and a shell consisting of secondary particles having a melting temperature which is greater than the melting temperature Tm of the PAEK polymer;
wherein core particles have a particle size distribution with a diameter D50 from 20 to 120 μm;
wherein the secondary particles have a particle size distribution with a diameter D50 of 10 μm or less; and
wherein D50 is defined by 50% by volume of the particles having a diameter less than D50.

The secondary particles may suitably have a D50 from 1 nm to 10 μm, for instance from 10 nm to 5 μm, such as from 100 nm to 2 μm.

The secondary particles may be particles of a second PAEK polymer having a higher melting temperature Tm than the Tm of the PAEK polymer of the core particles. The second PAEK of the secondary particles may be a single type of PAEK polymer or may be a blend or mixture of two or more such PAEK polymers.

Alternatively, or additionally, the secondary particles may be selected from glass, calcium hydroxyapatite, talc, metal, aluminium oxide or a mixture thereof. A mixture of such secondary particles with a second PAEK polymer may also be used.

The core-shell particles of the second aspect of the invention are also particles suitable for use in layer-wise formation of a component by selective sintering with electromagnetic radiation.

In particular, the PAEK polymer of the core particles is preferably the PEEK/PEDEK copolymer as disclosed in relation to the first aspect of the invention.

A third aspect of the invention provides a method of forming particles for use in layer-wise formation of a component by selective sintering with electromagnetic radiation, the method comprising:
i) providing primary particles consisting essentially of 60 to 100% by weight of polyaryletherketone, PAEK, polymer and 0 to 40% by weight of filler;
ii) subjecting the primary particles to mechanical fusion in a mechanical fusion chamber;
   wherein the temperature in the mechanical fusion chamber does not exceed the melting temperature Tm of the PAEK polymer but is greater than the glass transition temperature Tg of the PAEK polymer for a period of time whilst the mechanical fusion is carried out.

The particles formed using the method of the third aspect of the invention may be the particles of the first aspect of the invention, and so include particles having each the characteristics set out above in the context of the first aspect of the invention, with the method of the third aspect appropriately adjusted in order to generate particles with the disclosed characteristics.

The particles formed using the method of the third aspect of the invention may be the particles of the second aspect of the invention, and so include particles having each the characteristics set out above in the context of the second aspect of the invention, with the method of the third aspect appropriately adjusted in order to generate particles with the disclosed characteristics.

Hence, the method of the third aspect of the invention may further comprise providing secondary particles in step (i) and subjecting the secondary particles to mechanical fusion with the primary particles in the mechanical fusion chamber in step (ii);
wherein the secondary particles have a melting temperature which is greater than Tm;
wherein the primary particles have a particle size distribution with a diameter D50 from 20 to 120 μm;
wherein the secondary particles have a particle size distribution with a diameter D50 of 10 μm or less; and
wherein D50 is defined by 50% by volume of the particles having a diameter less than D50.

The secondary particles may be particles of a second PAEK polymer having a higher melting temperature Tm than the Tm of the PAEK polymer of the core particles. The second PAEK of the secondary particles may be a single type of PAEK polymer or may be a blend or mixture of two or more such PAEK polymers. In particular, the PAEK polymer of the core particles is preferably the PEEK/PEDEK copolymer as disclosed in relation to the first aspect of the invention.

Alternatively, or additionally, the secondary particles may be selected from glass, calcium hydroxyapatite, talc, metal, aluminium oxide or a mixture thereof. A mixture of such secondary particles with a second PAEK polymer may also be used.

The secondary particles may suitably have a D50 from 1 nm to 10 μm, for instance from 10 nm to 5 μm, such as from 100 nm to 2 μm.

The primary particles used in the method of the third aspect of the invention may consist essentially of, or consist of, 60 to 100% by weight of polyaryletherketone, PAEK polymer and from 0 to 40% by weight of filler. The PAEK polymer and filler of the primary particles of the third aspect of the invention are as set out above for the particles of the first aspect of the invention, and so this is not repeated here.

In particular, the PAEK polymer is preferably the PEEK/PEDEK copolymer as disclosed in relation to the first aspect of the invention.

When the primary particles consist essentially of, or consist of the PAEK polymer, the primary particles may be prepared by comminution and optionally classification, such as sieving, of the larger fragments of the PAEK polymer which result from the nucleophilic polycondensation process typically used to form PAEK polymers.

When the primary particles include filler, the primary particles may be prepared by blending of the filler with molten PAEK polymer, solidifying the resulting blend and then comminuting, and optionally classifying, for instance by sieving, the comminuted solid blend in order to form the primary particles.

In each of the above embodiments, any suitable comminution means may be employed, such as jet milling, pin milling, hammer milling, ball milling or roller milling.

In an embodiment, the primary particles may be free of filler, and so may consist essentially of, or consist of, PAEK polymer. In that case, the PAEK polymer may be comminuted and optionally classified in order to form the primary particles having a suitable particle size distribution.

The primary particles may suitably have a particle size distribution with a diameter D50 from 20 to 120 μm, preferably from 20 to 80 μm, more preferably from 35 to 70 μm, wherein D50 is defined by 50% by volume of the particles having a diameter less than D50. Suitably, the primary particles may have a D90, such that 90% by volume of the particles have a diameter less than D90, wherein D90 is 300 μm or less, preferably 150 μm or less, such as from 100 to 150 μm.

Suitably, the primary particles may have a D10, such that 10% by volume of the particles have a diameter less than D10, wherein D10 is 10 μm or more, such as from 10 to 30 μm.

The third aspect of the invention requires subjecting the primary particles to mechanical fusion.

Mechanical fusion is a process known in the prior art using mechanical energy to induce dispersion and bonding of fine particulate materials without the need for addition of binders. The process is a dry process in that no solvent is required. In mechanical fusion, feed material is charged into vessel equipped with a rotor blade arranged to rotate within the vessel, providing a stator wall, whilst leaving a narrow, uniform gap, typically about 1 mm, between the outer edge of the rotor blade and the stator wall of the vessel.

The high-speed rotation of the rotor blade causes the powder to be pressed against the stator wall due to centrifugal force. The mixture is circulated in the vessel and is subjected to compression and shear forces at the interface between the rotor blade edge and the vessel wall numerous times. It is believed that this results in densification and rounding of the particles of the powder.

The temperature of the powder particles may be monitored whilst they are subjected to mechanical fusion, for instance by means of a temperature monitoring device mounted in the stator wall.

The particle temperature does not exceed the melting temperature Tm of the PAEK polymer at any time whilst the mechanical fusion is carried out. In a preferred embodiment, the particle temperature is at least 10° C. lower than Tm, preferably at least 20° C. lower whilst the mechanical fusion is carried out. The particle temperature is greater than the glass transition temperature Tg of the PAEK polymer for a period of time whilst the mechanical fusion is carried out. More preferably, the particle temperature is at least 10° C. greater than the glass transition temperature Tg of the PAEK polymer for a period of time whilst the mechanical fusion is carried out, more preferably at least 20° C. greater. This period of time in which the particle temperature is greater than the glass transition temperature Tg of the PAEK polymer, whilst the mechanical fusion is carried out, is suitably at from 1 to 30 minutes, preferably 1 to 15 minutes, more preferably 2 to 15 minutes and even more preferably 2 to 10 minutes.

The Tg and Tm values for the PAEK polymer may be determined by measurement using Differential Scanning calorimetry (DSC). Crystallinity may also be measured by DSC. A suitable DSC apparatus is a Mettler Toledo DSC1 Star system with FRS5 sensor.

The Glass Transition Temperature (Tg), the Melting Temperature (Tm) and Heat of Fusion of Melting (ΔHm) for PAEK polymers may be determined using the following DSC method.

A dried sample of polymer powder is compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg (plus or minus 3 mg) sample of each film is scanned by DSC as follows:
Step 1 Perform and record a preliminary thermal cycle by heating the sample from 50° C. to 400° C. at 20° C./min.
Step 2 Hold for 5 minutes.
Step 3 Cool at 20° C./min to 50° C., recording the Tc and hold for 5 minutes
Step 4 Re-heat from 50° C. to 400° C. at 20° C./min, recording the Tg, Tm and ΔHm for this second heating endotherm.

From the DSC trace (exotherm as a function of time) resulting from the scan in step 3, To is obtained as the temperature at which the exotherm slope was a maximum.

Tm is the temperature at which the main peak of the melting endotherm reached a maximum value resulting from the scan in step 4. Tg is the onset of the glass transition.

The heat of fusion for melting (ΔHm) is obtained by connecting the point immediately following the glass transition to the point immediately following the melting peak to form a baseline. The integrated area between this baseline and the endotherm curve as a function of time yields the enthalpy of the melting transition. The mass normalised heat of fusion is calculated by dividing the enthalpy by the mass of the specimen (J/g). The level of crystallisation (%) may be determined by dividing the Heat of Fusion of the specimen by 130 J/g and multiplying by 100 to express as a percentage. This value of 130 J/g is the heat of fusion for totally crystalline PEEK, which is used as a reference value for this measurement, even when carried out on other PAEK polymers, or on PEEK/PEDEK copolymer.

Typically, for PEEK/PEDEK copolymer, the Tm value is about 300 to 310° C. and the Tg value is about 145 to 165° C. Hence a suitable temperature for mechanical fusion is from 180 to 280° C.

The temperature of the powder particles during mechanical fusion will increase as a result of the kinetic energy input by the mechanical fusion process and may be controlled by adjustment of the speed of the rotation blade. Additionally, the mechanical fusion apparatus may be provided with a cooling jacket, or other cooling means, arranged to remove heat from the stator wall and so enable control of the temperature of the powder particles whilst they are subject to mechanical fusion. Additionally, ambient air may be caused to flow through the interior of the mechanical fusion chamber as a further means to effect temperature control.

There are a number of commercially available mechanical fusion apparatuses available, such as the Mechanical Fusion AMS, the Micron Nobilta and the Micron Mechanical Fusion (Hosakawa-Nobilta).

Following the mechanical fusion of the powder, the third aspect of the invention may include the resulting particles having their particle size distribution adjusted by classification, such as sieving, for instance to eliminate fine particles that may be generated during the mechanical fusion. Such classification may improve the flow of the core/shell particles. Suitably the resulting core-shell particles may be classified to provide a particle size distribution with a diameter D50 from 20 to 120 μm, preferably 20 to 80 μm, more preferably from 35 to 70 μm, optionally with D90 of 300 μm or less, preferably 150 μm or less, such as from 100 to 150 μm and optionally with D10 of 10 μm or more, such as from 10 to 30 μm. D50, D90 and D10 are defined as set out hereinbefore.

The third aspect of the invention may also include subjecting the particles to tempering following the mechanical fusion. This may be put into effect by holding the particles at a temperature from 150° C. to 300° C. for a period from 1 to 48 hours, for instance from 170 to 230° C. for 12 to 36 hours. Such tempering may further improve the flow and bulk density characteristics of the powder particles.

The tempering may be carried out before, or after, any classification of the particles following the mechanical fusion step of the third aspect of the invention. Preferably, the tempering is carried out before classification for improved flowability of the resulting core/shell particles. The classification is preferably carried out with the particles to be classified at ambient temperature, say from 10° C. to 35° C.

A further aspect of the invention provides a method of manufacturing a component from particles by selective sintering by means of electromagnetic radiation, wherein the particles are the particles of the first or second aspects of the invention or the particles formed by the method of the third aspect of the invention.

Another aspect of the invention provides a component comprising the particles of the first or second aspects of the invention or the particles formed by the method of the third aspect of the invention, wherein the particles are mutually bonded together to form the component.

Specific embodiments of the invention will now be described by reference to the following Examples.

### EXAMPLE

The primary particles were PAEK polymer particles consisting of PEEK/PEDEK copolymer having a molar ratio of PEEK:PEDEK of 75:25 PEEK to PEDEK ratio. PEEK/PEDEK copolymer was made by the general process as set out in Example 1 of international patent application publication WO2014/207458A1.

Preparation of 0.5 mol polyetheretherketone (PEEK)-polyetherdiphenyletherketone (PEDEK) copolymer: A 0.5 litre flanged flask fitted with a ground glass lid, stirrer/stirrer guide, nitrogen inlet and outlet was charged with 4,4′-diflurobenzophenone (111.29 g, 0.510 mol), 1,4-dihydroxybenzene (41.30 g, 0.375 mol), 4,4′-dihydroxydiphenyl (23.28 g, 0.125 mol) and diphenylsulphone (241.07 g) and purged with nitrogen for 1 hour. The contents were then heated under a nitrogen blanket to 160° C. to form an almost colourless solution. While maintaining a nitrogen blanket, dried sodium carbonate (53.00 g, 0.5 mol) and potassium carbonate (2.76 g, 0.02 mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 315° C. at 1° C./min and held for approximately 60 minutes or until the desired shear viscosity (SV) was reached as indicated by the torque rise on the stirrer. The required torque rise was determined from a calibration graph of torque rise versus SV. The reaction mixture was then poured into a foil tray, allowed to cool, milled and washed with 2 litres of acetone and then with warm water at a temperature of 40-50° C. until the conductivity of the waste-water was <2 mS. The resulting polymer particles were dried in an air oven for 12 hours at 120° C.

Two 75:25 PEEK/PEDEK polymers (molar ratio of PEEK to PEDEK monomer units) were used in the examples below, each prepared according to the process set out above, one with a high shear viscosity (350 Pa·s) and the other of lower shear viscosity (280 Pa·s).

The particle size distribution of the primary particles prior to being subjected to mechanical fusion was approximately D50-60 μm, D10-20 μm and D90-120 μm for each of the two different polymer particles.

The mixture was subjected to mechanical fusion in a laboratory-scale mechanical fusion apparatus—specifically a Nobilta AMS-mini mechanofusion machine (Hosokawa Micron Corp., Japan) using a blade rotor set up with a 1 mm impeller gap. 30 g of primary particles were charged into the chamber. Particles were subjected to mechanical fusion at a rotor speed of approximately 4000 rpm for 5 minutes.

An air purge of 2.5 L/minute was used (gas flow through the mechanical fusion chamber) and no cooling was applied to the jacket. This gave a temperature in the fusion chamber of approximately 200° C.

The mechanical fusion was carried out for approximately 5 minutes with the temperature in the mechanical fusion chamber at about 200° C.

Following the mechanical fusion, the resulting particles were found to have a particle size distribution in which the mean particle size was substantially unchanged compared to the original primary particles, but the width of the distribution was marginally broader.

The primary particles and the particles resulting from the primary particles being subjected to mechanical fusion (post-MF) were measured by mercury intrusion porosimetry using an AutoPore IV 9620 mercury porosimeter (Micromeritics) as detailed above. The results are shown in Table 1.

TABLE 1

| | Polymer A | | | Polymer B | | |
|---|---|---|---|---|---|---|
| | (shear viscosity 280 Pa · s) | | | (shear viscosity 350 Pa · s) | | |
| | Primary | Post-MF | % change | Primary | Post-MF | % change |
| Total Intruded | 1.924 | 1.085 | −43.6 | 1.806 | 0.908 | −49.7 |
| Volume (mL/g) | | | | | | |
| Total Pore Area | 28.51 | 23.21 | −18.6 | 27.59 | 26.63 | −3.5 |
| m²/g | | | | | | |
| Mean Pore | 0.270 | 0.187 | −30.7 | 0.262 | 0.136 | −47.9 |
| Diameter (μm) | | | | | | |
| Skel. Dens. (g/mL) | 1.185 | 1.233 | 4 | 1.204 | 1.230 | 2.2 |
| Porosity (%) | 69.52 | 57.23 | −17.7 | 68.59 | 52.76 | −23.1 |

Total intrusion volume, total pore area and skeletal density were measured at the highest intrusion pressure of 59950 psia.

It is evident from the results that the mechanical fusion step results in a major reduction in the total porosity of the particles, with the reduction in porosity arising from reductions in the volumes of both interparticle pores and intraparticle pores.

In summary, particles are provided for use in layer-wise formation of a component by selective sintering by electromagnetic radiation. The particles consist essentially of 60 to 100% by weight of polyaryletherketone (PAEK) polymer and 0 to 40% by weight of filler. The particles have a low total porosity from 0.58 to 0.40. Also provided is a method for forming such particles by mechanical fusion. Components made from the particles by selective sintering by means of electromagnetic radiation exhibit improved properties. The reduction in porosity of the particles compared to particles which have not been subjected to mechanical fusion results in components of greater density with improved mechanical characteristics arising from better packing of the particles forming the component during the selective sintering process.

The described and illustrated embodiments are to be considered as illustrative and not restrictive in character, it being understood that preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim.

1. Particles, for use in layer-wise formation of a component by selective sintering with electromagnetic radiation, the particles consisting essentially of, or consisting of, 60 to 100% by weight of polyaryletherketone, PAEK polymer and 0 to 40% by weight of filler, wherein the particles have a total porosity from 0.58 to 0.40 derived from comparison of open pore volumes of a sample of the particles measured by mercury intrusion porosimetry at pressures of 0.33 psia (2.3 kPa) and 59950 psia (413.3 MPa) respectively.

2. Particles according to claim 1 wherein the PAEK polymer is a copolymer comprising repeat units of formula: 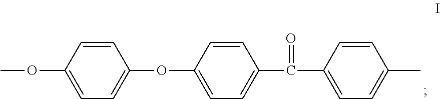
and
repeat units of formula 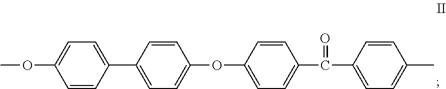
wherein at least 95 mol % of the copolymer repeat units are repeat units of formula I and of formula II;
wherein the repeat units I and II have a molar ratio I:II from 55:45 to 80:20.

3. Particles according to claim 1, wherein the particles have a particle size distribution with a diameter D50 from 20 to 120 μm, wherein D50 is defined by 50% by volume of the particles having a diameter less than D50.

4. Particles according to claim 1, consisting, or consisting essentially, of the PAEK polymer.

5. Core-shell particles consisting of core particles which are particles according to claim 1 and a shell consisting of secondary particles having a melting temperature which is greater than the melting temperature Tm of the PAEK polymer;
wherein core particles have a particle size distribution with a diameter D50 from 20 to 120 μm;
wherein the secondary particles have a particle size distribution with a diameter D50 of 10 μm or less; and
wherein D50 is defined by 50% by volume of the particles having a diameter less than D50.

6. Core-shell particles according to claim 5 wherein the secondary particles are selected from glass, calcium hydroxyapatite, talc, metal, aluminium oxide or a mixture thereof.

7. A method of forming particles for use in layer-wise formation of a component by selective sintering with electromagnetic radiation, the method comprising:
i) providing primary particles consisting essentially of 60 to 100% by weight of polyaryletherketone, PAEK, polymer and 0 to 40% by weight of filler;
ii) subjecting the primary particles to mechanical fusion in a mechanical fusion chamber;
wherein the temperature in the mechanical fusion chamber does not exceed the melting temperature Tm of the PAEK polymer but is greater than the glass transition temperature Tg of the PAEK polymer for a period of time whilst the mechanical fusion is carried out.

8. The method of claim 7 wherein the primary particles have a total porosity from 0.65 to 0.80, derived from comparison of open pore volumes of a sample of the particles measured by mercury intrusion porosimetry at pressures of 0.33 psia (2.3 kPa) and 59950 psia (413.3 MPa) respectively.

9. The method of claim 7 wherein the PAEK polymer is a copolymer comprising repeat units of formula: 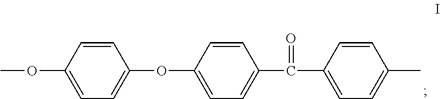
and
repeat units of formula 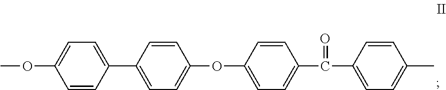
wherein at least 95 mol % of the copolymer repeat units are repeat units of formula I and of formula II;
wherein the repeat units I and II have a molar ratio I:II from 55:45 to 80:20.

10. The method of claim 7, wherein the primary particles have a particle size distribution with a diameter D50 from 20 to 120 μm, wherein D50 is defined by 50% by volume of the particles having a diameter less than D50.

11. The method of claim 7, wherein the primary particles consist essentially of, or consist of, the PAEK polymer.

12. The method of claim 7, wherein the period of time, in which the particle temperature is greater than the glass transition temperature Tg of the PAEK polymer whilst the mechanical fusion is carried out, is from 2 to 10 minutes.

13. The method of claim 7, wherein the method further comprises providing secondary particles in step (i) and subjecting the secondary particles to mechanical fusion with the primary particles in the mechanical fusion chamber in step (ii);
wherein the secondary particles have a melting temperature which is greater than Tm;
wherein the primary particles have a particle size distribution with a diameter D50 from 20 to 120 μm;
wherein the secondary particles have a particle size distribution with a diameter D50 of 10 μm or less; and
wherein D50 is defined by 50% by volume of the particles having a diameter less than D50.

14. The method of claim 13 wherein the secondary particles are selected from glass, calcium hydroxyapatite, talc, metal, aluminium oxide or a mixture thereof.

15. A method of manufacturing a component from particles by selective sintering by means of electromagnetic radiation, wherein the particles are the particles of claim 1.

16. A component comprising the particles of claim 1, wherein the particles are mutually bonded together to form the component.

17. A method of manufacturing a component from particles by selective sintering by means of electromagnetic radiation, wherein the particles are the particles formed by the method of claim 7.

18. A component comprising the particles formed by the method of claim 7, wherein the particles are mutually bonded together to form the component.
